(19) United States
(12) Patent Application Publication
(10) Pub. No.: US 2008/0143601 A1
(43) Pub. Date: Jun. 19, 2008

(54) BUTLER MATRIX IMPLEMENTATION

(75) Inventor: Yufeng Xu, Kanata (CA)

Correspondence Address: WORKMAN NYDEGGER, 60 EAST SOUTH TEMPLE, 1000 EAGLE GATE TOWER, SALT LAKE CITY, UT, 84111, US

(73) Assignee: TenXc Wireless Inc., Ottawa (CA)

(21) Appl. No.: 11/946,979

(22) Filed: Nov. 29, 2007

(30) Foreign Application Priority Data
Nov. 30, 2006 (CA) 2,568,136

(51) Int. Cl. H01Q 3/00

(52) U.S. Cl. 342/373

(57) ABSTRACT

A novel implementation of a planar 4×4 RF Butler matrix layout is disclosed that permits, by moving the beam ports to the interior of the layout, for combining beam ports that are not disposed on the same side of the layout without the imposition of long delay times or crossover points. The implementation admits of using microstrip and/or stripline technologies.

### CROSS-REFERENCE TO RELATED APPLICATIONS

This application claims priority to Canadian Application No. 2,568,136, filed Nov. 30, 2006, which for purposes of disclosure is incorporated herein by specific reference.

### BACKGROUND OF THE INVENTION

1. The Field of the Invention

The present invention relates to Butler matrix beamforming networks, more particularly to an improved layout for a 4×4 Butler matrix.

2. The Relevant Technology

In wireless communication systems, sectorized antennas have increasingly been replaced by phased array or beamforming antennas. Such antennas comprise an array of fixed antenna elements connected by a beamforming network between the antenna elements and the beam ports. The beam patterns for the antenna are determined by the phase and amplitude relationships of the beam-forming network. The phase and amplitude relationship of the signals between the antenna elements and beam ports may be adjusted to create a shaped beam pattern.

Thus, for example, a single antenna array may generate centre, left and right beams of antenna energy simply by adjusting the phase and amplitude of the antenna signal in different time slots.

The phase and amplitude adjustment is typically effected by beamforming networks that take a signal to be transmitted and distribute them in coherent fashion to each of the antenna elements, while introducing prescribed phase and amplitude variations to the elements to create the desired phase and amplitude relationship between the elements. For receiving operations, the signals from each element are phase and amplitude weighted before being combined.

However, to permit a single antenna array to generate different beams, the array needs to be connected to beamforming networks corresponding to each beam. As a result, a single antenna element may be connected to several beamforming networks to create multiple beams.

Significant combining losses will be experienced in simply connecting the antenna elements to their respective beamforming networks. As a general rule of thumb, about 3 dB power loss will be experienced when two beam forming networks are connected to one antenna element array.

Butler matrices are a well-known mechanism by which a plurality of beams may be simultaneously created and connected to an array of antenna elements while minimizing combining losses. By arranging the splitting and combining of signals using 90° hybrid elements, the Butler matrix creates simultaneous multiple beams at the beam ports when the element ports are connected with the antenna element array. For example, a 4×4 Butler matrix can be used to generate 4 orthogonal beams at the four beam ports with 4 antenna elements.

The ability to simultaneously create multiple beams with minimal losses is very attractive and for this reason, Butler matrix beamforming networks have proved very popular.

FIG. 1 shows a block diagram showing the implementation of a 4×4 Butler matrix with beam forming networks, which is well known in the art. In general, an m×m Butler matrix will create m beams using m antenna elements.

The exemplary Butler matrix comprises four beam ports, designed B1 150, B2 155, B3 160, and B4 165, four element ports, designated E1 100, E2 105, E3 110, and E4 115; four 90° hybrid elements designated H1 120, H2 125, H3 140, and H4 145; and two 45° phase shifters designated PS1 130 and PS2 135 respectively.

For purposes of explanation only, the operation of the exemplary Butler matrix will be explained only in relation to transmission operations. Nevertheless, having regard to the reciprocity principle, the Butler matrix will function in similar fashion for reception operations.

Each beam port 150, 155, 160, 165 accepts an RF signal to be transmitted along an associated orthogonal beam by each of the antenna elements.

Each element port 100, 105, 110, 115 is connected to a corresponding antenna element and passes on the RF signal that it receives to its corresponding antenna element for transmission.

Each hybrid element 120, 125, 140, 145, also known as a hybrid coupler or quadrature coupler, accepts two inputs and generates two outputs that are each a combination of the signals at its inputs.

A hybrid is a four-port device with two input ports and two output ports. The output signals from the two output ports are shifted 90° in phase relative to each other and are reduced in amplitude by 3 dB because of the equal power splitting of the hybrid element. There is no energy loss in this power splitting process.

Suitable hybrid elements known in the art include Lange couplers, branchline couplers, overlay couplers, edge couplers and short-slot hybrid couplers, and other 4 port couplers. In the convention shown in the Figure, the output on the right side is delayed in phase by 90° relative to the output at the left side when the input signal is applied to the left side of the 90° hybrid, while the amplitudes are equal and 3 dB below the input level. By the same token, the output on the left side is delayed in phase by 90° relative to the output at the right side when the input signal is applied to the right side of the 90° hybrid, while again the amplitude are equal and 3 dB below the input level.

Each phase shifter 130, 135 accepts a single input and generates a single output that is delayed in phase by 45°.

The phase and amplitude at the element ports of the Butler matrix can be derived by tracing the paths that the input signal follows through the 90° hybrid elements. Because only relative phases among elements are relevant in beam forming, the fixed phase shifts introduced by the phase shifters can be omitted in the derivation. Thus, by following through the various paths shown, it can be seen that the phase relationship of the antenna elements corresponding to element ports E1-E4 have phase relationships relative the phase of each beam port B1-B4 as shown in Table 1:

| Beam | Element | Element | Element | Element | Phase Slope |
|---|---|---|---|---|---|
| Port | E1 | E2 | E3 | E4 | among elements |
| B1 | −45° | −90° | −135° | −180° | 45 |
| B2 | −135 | 0 | −225 | −90 | 135 |
| B3 | −90° | −225 | 0° | −135° | −135 |
| B4 | −180° | −135 | −90° | −45 | −45 |

In this way, the Butler matrix outputs a combination of all the input beam signals to each element port, with an ideal signal level of 6 dB below the input signal, corresponding to the path of each signal through two hybrid elements. The signal power is equally splitted among the element ports. There is no power loss in this process due to the combing and splitting of the signal. As a result, the Butler matrix acts as a beamforming network for the associated beam elements without the additional combining losses that would ordinarily result by simply connecting together discrete beamforming networks.

There have been some attempts at reducing the 4×4 Butler matrix shown in FIG. 1 into a two-dimensional planar circuit layout that may be implemented in a stripline or microstrip embodiment on a printed circuit board.

The difficulty in reducing the 4×4 Butler matrix to planar circuit form has to do with the two cross-over points 160, 165 shown in FIG. 1. Introducing cross-over points in a printed circuit board layout involves an additional photo-mask step, which adds complexity and cost to the implementation. Additionally, there is an increased risk of signal loss and reflection from parasitic capacitance and resistance created at the cross-over point that could adversely affect the circuit performance. For these and other reasons, cross-over points are frequently difficult to implement in an RF circuit.

One alternative attempt involves the introduction of relatively long delay lines to the PCB layout, in order to avoid cross-over points. However, in RF circuits such as this, it is important to carefully match the lengths of the delay lines to avoid the unintended introduction of additional phase delays, which would adversely impact the beam shape generated by the antenna array.

FIG. 2 shows a planar microwave implementation of the exemplary 4×4 Butler matrix of FIG. 1, which is also known in the art. As with FIG. 1, the exemplary Butler matrix of FIG. 2 comprises four beam ports, designed B1 250, B2 255, B3 260, and B4 265, four element ports, designated E1 200, E2 205, E3 210, and E4 215; four 90° hybrid elements designated H1 220, H2 225, H3 240, and H4 245; and two 45° phase shifters designated PS1 230 and PS2 235 respectively.

However, here the implementation repositions the beam ports B1-B4 250, 255, 260, 265 and the element ports E1-E4 200, 205, 210, 215 in such a fashion that the Butler matrix may be implemented without the use of crossovers or long lead lines.

The reorientation of the circuit layout provides that beam ports B1 250 and B2 255 are disposed on one side (in the figure, the left side) of the circuit while beam ports B3 260 and B4 265 are disposed on a second side (in the figure, the right side) of the circuit across from or opposite to the first side. Similarly, element ports E1 200 and E3 210 are disposed on a third side (in the figure, the bottom side) between the first and second sides of the circuit and element ports E2 205 and E4 215 are disposed on a fourth side (in the figure, the top side) between the first and second sides of the circuit and opposite to the third side.

Each of the hybrids 220, 225, 240, 245 are preferably implemented as a branch line coupler connecting to an arm of another hybrid. In the embodiment of FIG. 2, the hybrids are disposed on each of four sides of a rectangular area, with hybrid H1 220 is disposed on the side proximate to the element port pair E1 200 and E3 210. Hybrid H2 225 is disposed on the side proximate to the element port pair E2 205 and E4 215. Similarly, hybrid H3 240 is disposed on the side proximate to the beam port pair B1 250 and B2 255, while hybrid H4 245 is disposed on the side proximate to the beam port pair B3 260 and B4 265.

The phase shifters PS1 230 and PS2 235 are implemented as transmission lines that have a length that exceeds the connector 231 between legs of hybrids H2 225 and H3 240, and the connector 232 between legs of hybrids H1 220 and H4 245 by an amount equal to ⅛ of the operating wavelength of the circuit.

In K. Uehara, et al., “New indoor high-speed radio communication system” IEEE Veh. Technol. Conf. Dig., 1995, the element ports of a 4×4 Butler matrix are moved to the interior of the structure in order to put the element ports in a row and in a certain sequential order.

However, in beamforming antenna systems, there is not infrequently a desire to combine two or more beam ports, so as to drive two beamformers with a common signal and create combined beams. This can be implemented by adding combiners and/or splitters between the multiple beam ports. The shapes of the combined beam patterns can be further controlled by manipulating the phase and amplitude of the ports of the beam combiners/splitters.

For example, a conventional 120° cellular wireless sector is bisected longitudinally in order to generate two sub-sectors.

One of the mechanisms contemplated for creating such a sector is using a 4×4 Butler matrix where beam ports B1 and B3 are driven by a common signal and where beam ports B2 and B4 are similarly driven by a common signal. The combined beam pattern shapes can be controlled by adjusting the amplitudes and phases of signals between the combined beam ports and the beam ports B1, B3 and B2,b4.

If it were desired to combine beam ports B1 250 and B2 255 and beam ports B3 260 and B4 265 it would be a relatively simple task with the embodiment of FIG. 2.

However, it is apparent from a review of FIG. 2 that introducing combiners between beam ports B1 250 and B3 260 and between beam ports B2 255 and B4 265, would involve the imposition of long transmission lines and/or cross-over points and the attendant difficulties that such imposition entails.

Another example of a potential connection between non-adjacent pairs of beam ports is the scenario where it is desired to create one central beam and two side beams. For example, one may desire to combine beam ports B1 250 and B4 265 to create the central beam. Again, from a review of FIG. 2, it is apparent that the introduction of a connection between beam ports B1 250 and B4 265 would involve the imposition of long lead lines and/or cross-over points.

### SUMMARY OF THE INVENTION

As such, it is desirable to develop a novel implementation of a planar 4×4 Butler matrix layout that permits for combining beam ports that are not disposed on the same side of the layout without the imposition of long delay lines or cross-over points.

Further, it is desirable to provide a Butler matrix that can be implemented using microstrip planar transmission lines.

Still further, it is desirable to provide a Butler matrix that can be implemented using stripline planar structures.

In a first broad aspect, the present invention provides a planar layout for a Butler matrix beamforming network having a plurality of beam ports for accepting corresponding input RF signals and a plurality of element ports for generating coherent output signals to a corresponding plurality of antenna elements, whereby the phase relationship between the output signals at each of the plurality of antenna elements in response to at least one input RF signal generates at least one corresponding antenna beam pattern, the element ports and the beam ports being interconnected by a network of hybrid elements and a plurality of phase shifter elements, wherein the beam ports are located within the interior of the layout.

In a second broad aspect, the present invention provides a planar layout for a Butler matrix beamforming network having a plurality of beam ports for accepting corresponding input RF signals and a plurality of element ports for generating coherent output signals to a corresponding plurality of antenna elements, whereby the phase relationship between the output signals at each of the plurality of antenna elements in response to at least one input RF signal generates at least one corresponding antenna beam pattern, the element ports and the beam ports being interconnected by a network of hybrid elements and a plurality of phase shifter elements, wherein the network comprises a structure, wherein the beam ports are located interior to the structure.

### BRIEF DESCRIPTION OF THE DRAWINGS

The embodiments of the present invention will now be described by reference to the following figures, in which identical reference numerals in different figures indicate identical elements and in which:

FIG. 1 is a prior art block diagram of a 4×4 Butler matrix;

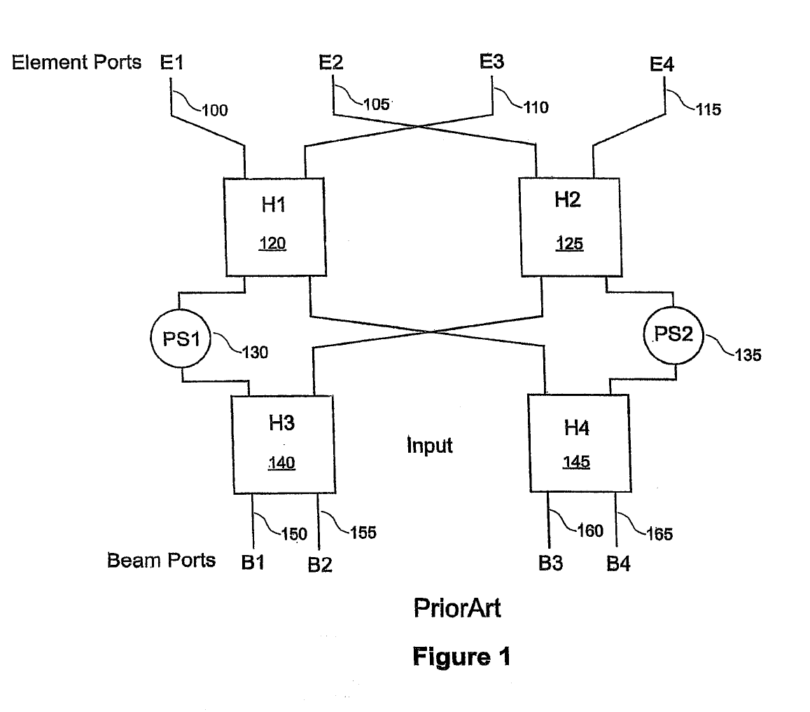

FIG. 2 is a prior art board layout diagram of the 4×4 Butler matrix of the embodiment of FIG. 1;

FIG. 3 is a board layout diagram of the 4×4 Butler matrix of the embodiment of FIG. 1 according to an embodiment of the present invention;

FIG. 4 is a board layout diagram of a 4×4 Butler matrix in accordance with the embodiment of FIG. 3, and including a plurality of beam combiners according to a first embodiment of the present invention;

FIG. 5 is a board layout diagram of a 4×4 Butler matrix in accordance with the embodiment of FIG. 3, and including a single beam combiner according to a second embodiment of the present invention; and

FIG. 6 is a plot of beam pattern response based on the measured data of the 4×4 Butler matrix beamformer of the embodiment of FIG. 4 as a function of azimuth angle.

### DETAILED DESCRIPTION OF THE PREFERRED EMBODIMENTS

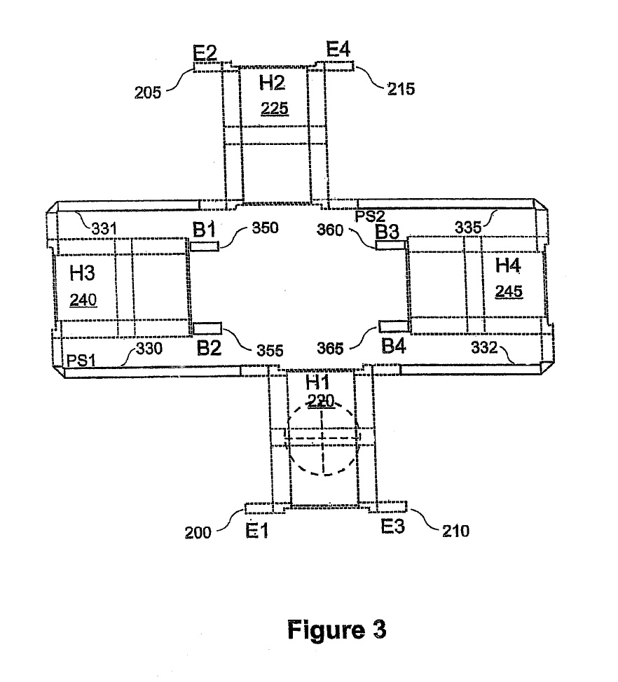

Turning now to FIG. 3, there is shown an exemplary embodiment of a novel two-dimensional planar printed circuit board layout of a 4×4 Butler matrix having the capability of combined beam port pairs according to the present invention.

The diagram comprises four element ports, respectively designated E1 200, E2 205, E3 210 and E4 215, four beam ports, respectively designated B1 350, B2 355, B3 360 and B4 365, four hybrids, respectively designated H1 220, H2 225, H3 240 and H4 245, two 45° phase shifters, respectively designated PS1 330 and PS2 335 and two connectors designated 331 and 332.

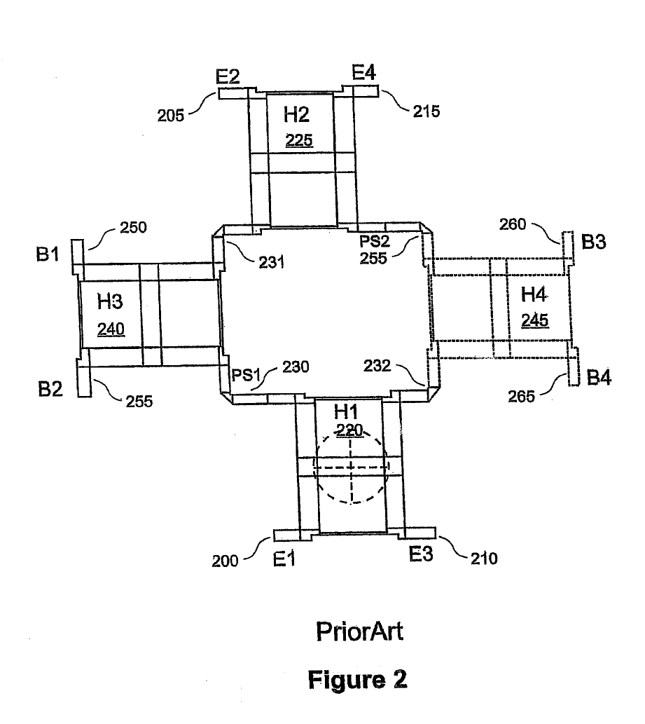

Electrically, the Butler matrix of FIG. 3 is identical to that of FIG. 2. It differs primarily in the inward-facing orientation of the beam ports 350, 355, 360 and 365, and consequential changes to the length of the phase shifters 330 and 335 and connectors 331 and 332.

The inward-facing orientation of the beam ports permits the interconnection of beam port pairs B1 350 and B3 360 and B2 355 and B4 365 or of a single beam port pair, whether B1 350 and B4 365 or B2 355 and B3 360 without using a cross-over point or long lead lines.

The cost of providing this inward-facing orientation is increased length of the transmission line 331 and 332 and of the phase shifters PS1 330 and PS2 335 in order to provide sufficient space for the beam ports. Because the Butler matrix beamformer operates on a differential phase basis, the length difference between transmission line 331 and phase shifter PS1 330 provides the desired phase shift that implements phase shifter PS1. Similarly, the length difference between transmission line 335 and phase shifter PS2 332 provides the desired phase shift that implements phase shifter PS2.

Introduction of the RF signal to each beam port is unaffected because such planar implementations of the Butler matrix beamformer, whether in the inventive embodiment of FIG. 3 or the well known embodiment of FIG. 2, is typically introduced in a direction normal to the plane of the PC board on which the Butler matrix beamformer is etched, such as from above.

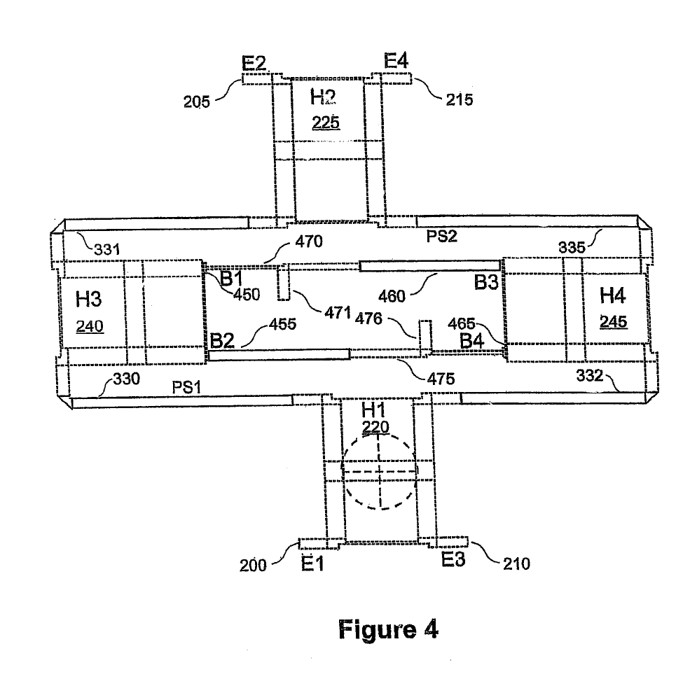

The connection between beam port pairs B1 450 and B3 460 and B2 455 and B4 465 may be seen in FIG. 4. Combiners 470 and 475 respectively connect beam port pairs B1 450 and B3 460 and B2 455 and B4 465. An input stub 471 and 476, comprising a T junction is appended to each combiner 470, 475. However those having ordinary skill in this art will readily appreciate that other combiners, such as Wilkinson dividers, may be used instead.

The phase relationship between the signal entering each of the beam ports may be adjusted by varying the relative lengths of the legs of the T-junction of the input stub 471, 476. The amplitude of the signals entering each of the beam ports may be adjusted by varying the width of the legs of the T-junction of the input stub 471, 476.

Thus, in operation, a common RF signal may be introduced to each of the input stubs 471, 476 with the assurance that the signal will enter each associated beam port in a pre-determined phase and amplitude relationship in order to create the desired combined beams.

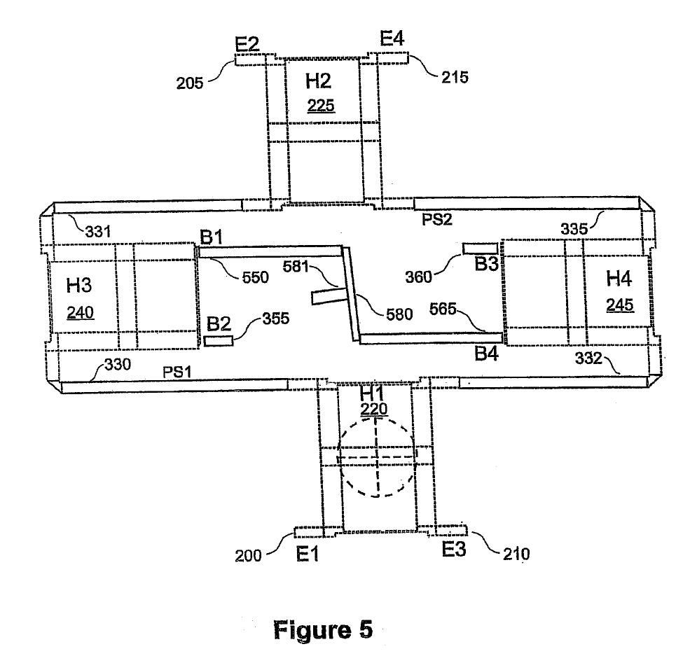

Turning now to FIG. 5, there is shown a second alternative embodiment in which beam port pair B1 550 and B4 565 are connected by a single combiner 580 having an associated input stub 581. In this way, a common RF signal is introduced to the input stub 581 and separate RF signals are introduced to each of beam ports B2 355 and B3 360, so as to create a single central beam using the combined beam ports B1 550 and B4 565 and smaller side beams using beam ports B2 355 and B3 360.

Those having ordinary skill in this art will readily recognize that it would be equally plausible to connect beam port pairs B2 355 and B3 360 and to leave beam ports B1 550 and B4 565 uncombined, should there be a desire to do so. Those having ordinary skill in this art will also readily recognize that there may nevertheless be interest in providing inward-facing beam ports as shown in FIG. 3, even if there was no intention of combining any of them or to combine beam port pairs B1 350 and B2 355 and B3 360 and B4 365, for example, to centralize the routing of cables bearing the input signals through a single conduit, rather than to have to provide a plurality of input conduits.

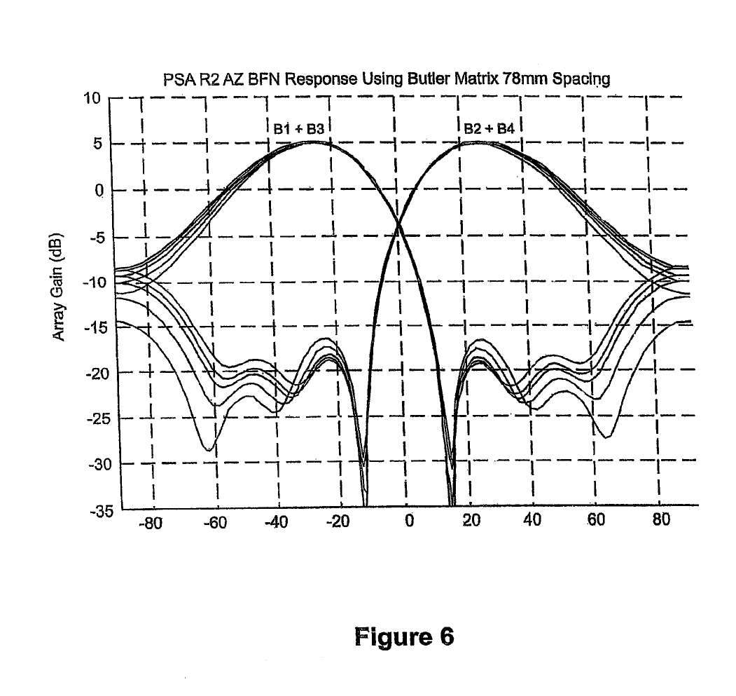

Turning now to FIG. 6, there is shown a plot of the array beam pattern calculated from the measured results of the 4×4 Butler matrix beamformer of the embodiment of FIG. 4 which has two beams as the results the beam combining from B1, B4 and B2, B3.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of volatile and non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

What is claimed is:

1. A planar layout for a Butler matrix beamforming network having a plurality of beam ports for accepting corresponding input RF signals and a plurality of element ports for generating coherent output signals to a corresponding plurality of antenna elements, whereby the phase relationship between the output signals at each of the plurality of antenna elements in response to at least one input RF signal generates at least one corresponding antenna beam pattern,
the element ports and the beam ports being interconnected by a network of hybrid elements and a plurality of phase shifter elements,
wherein the beam ports are located within the interior of the layout.

2. A planar layout for a Butler matrix beamforming network according to claim 1, wherein the layout minimizes the length of connectors between elements thereof.

3. A planar layout for a Butler matrix beamforming network according to claim 1, characterized by the absence of any crossover points between elements thereof.

4. A planar layout for a Butler matrix beamforming network according to claim 1, wherein the beam ports are co-located in proximity to one another.

5. A planar layout for a Butler matrix beamforming network according to claim 1, wherein a first pair of beam ports may be connected to a first common input.

6. A planar layout for a Butler matrix beamforming network according to claim 5, wherein the first pair of beam ports are connected by a stub connector therebetween.

7. A planar layout for a Butler matrix beamforming network according to claim 6, wherein an input stub extends from the stub connector at an intermediate point and is adapted to be connected to the first common input.

8. A planar layout for a Butler matrix beamforming network according to claim 5, wherein a second pair of beam ports may be connected to a second common input.

9. A planar layout for a Butler matrix beamforming network according to claim 1, wherein the plurality of beam ports are 4 in number.

10. A planar layout for a Butler matrix beamforming network according to claim 1, wherein the plurality of element ports are 4 in number.

11. A planar layout for a Butler matrix beamforming network according to claim 1, wherein at least one of the plurality of phase shifter elements delay a phase of signals passing therethrough by 45°.

12. A planar layout for a Butler matrix beamforming network according to claim 11, wherein at least one of the plurality of phase shifter elements comprise a connector having a length that exceeds a corresponding conductive path by ⅛ of an operational wavelength.

13. A planar layout for a Butler matrix beamforming network according to claim 12, wherein the plurality of phase shifter elements are 2 in number.

14. A planar layout for a Butler matrix beamforming network according to claim 1, wherein at least one of the plurality of hybrid elements has 2 inputs.

15. A planar layout for a Butler matrix beamforming network according to claim 14, wherein at least one of the plurality of hybrid elements has 2 outputs.

16. A planar layout for a Butler matrix beamforming network according to claim 1, wherein one of the outputs delays a signal entering a first input by 90°.

17. A planar layout for a Butler matrix beamforming network according to claim 16, wherein the one of the output signal is 6 dB less than the input.

18. A planar layout for a Butler matrix beamforming network according to claim 1, wherein one of the outputs delays a signal entering a second input by 180°.

19. A planar layout for a Butler matrix beamforming network according to claim 1, wherein the one of the outputs is 6 dB less than the input signal.

20. A planar layout for a 4×4 Butler matrix beamforming network according to claim 1, wherein the plurality of hybrid elements are 4 in number.

21. A planar layout for a 4×4 Butler matrix beamforming network according to claim 1, wherein the layout is etched on a printed circuit board.

22. A planar layout for a 4×4 Butler matrix beamforming network according to claim 21, wherein the layout is etched in a single layer.

23. A planar layout for a 4×4 Butler matrix beamforming network according to claim 1, wherein the layout uses a layout technology chosen from the group consisting of stripline and microstrip.

24. A planar layout for a Butler matrix beamforming network having a plurality of beam ports for accepting corresponding input RF signals and a plurality of element ports for generating coherent output signals to a corresponding plurality of antenna elements, whereby the phase relationship between the output signals at each of the plurality of antenna elements in response to at least one input RF signal generates at least one corresponding antenna beam pattern,
the element ports and the beam ports being interconnected by a network of hybrid elements and a plurality of phase shifter elements,
wherein the network comprises a structure;
wherein the beam ports are located interior to the structure.
